(19) United States
(12) Patent Application Publication
(10) Pub. No.: US 2009/0122789 A1
(43) Pub. Date: May 14, 2009

(54) APPARATUS AND METHOD FOR FILE TRANSFER USING IMS SERVICE IN A MOBILE COMMUNICATION TERMINAL

(75) Inventor: Ho-Seok Seong, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/265,134

(22) Filed: Nov. 5, 2008

(30) Foreign Application Priority Data
Nov. 9, 2007 (KR) 10-2007-0114051

(51) Int. Cl. H04L 12/66

(52) U.S. Cl. 370/352

(57) ABSTRACT

An apparatus and method for file transfer using IMS service in a mobile communication terminal is provided. In the method, Circuit-Switched (CS) call is connected with a corresponding terminal through a CS network. Capability information of the corresponding terminal is acquired according to performing a Session Initiation Protocol (SIP) capability negotiation process with an IP Multimedia Subsystem (IMS) proxy server through a Packet Switched (PS) network. Files are transferred to the corresponding terminal through a File Transfer Protocol (FTP) service according to using the acquired capability information of the corresponding terminal.

### PRIORITY

This application claims the benefit under 35 U.S.C. § 119(a) of a Korean patent application filed in the Korean Intellectual Property Office on Nov. 9, 2007 and assigned Serial No. 10-2007-0114051, the entire disclosure of which is hereby incorporated by reference.

### BACKGROUND OF THE INVENTION

1. Field of the Invention

The present invention relates to a mobile communication terminal. More particularly, the present invention relates to an apparatus and method for file transfer using an IP Multimedia Subsystem (IMS) service in a mobile communication terminal.

2. Description of the Related Art

Recently, based on a broadband wireless Internet service and Internet Protocol (IP), research and development of a next-generation communication system, which is able to provide various multimedia services along with a voice service, are being actively pursued. To implement various multimedia services efficiently and inexpensively, a technology based on a combined service of wire and wireless is required. Therefore, IP Multimedia Subsystems (IMS) based on a Packet Switched (PS) network are being developed.

The IMS is an opening architecture enabling IP multimedia services at a mobile, wire or convergence environment, based on the Session Initiation Protocol (SIP) signaling. The IMS is able to generate, control or change an application regardless of a network type or a platform type, and implement the multimedia communication for a large amount of data such as video data.

The mobile communication terminals are performing various functions such as a data communication function, a multimedia data process function, a camera and electronic scheduler function in addition to a voice call function. Accordingly, the mobile communication terminals use extraordinarily improved systems. Moreover, the mobile communication terminals are able to communicate with a peripheral device such as a desktop computer, a notebook computer and a Personal Data Assistant (PDA) and therefore it is possible to backup a directory.

Conventional methods for file transfer between mobile communication terminals are a Video Sharing method and an Instant Messaging (IM) method. However, the Video Sharing method only supports a transfer of the video data and the IM method only supports a transfer of text data.

Therefore, there is a need to provide a method and an apparatus for file transfer between mobile communication terminals, which is able to support different types of data.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for file transfer using an IMS service in a mobile communication terminal.

Another aspect of the present invention is to provide an apparatus and a method for acquiring a unique call-ID of a terminal and a corresponding terminal by connecting with an IMS proxy server, and transferring files to the corresponding terminal by using the acquired unique call-ID in a mobile communication terminal based on an IMS service.

According to an aspect of the present invention, a method for transferring files in a first mobile communication terminal is provided. The method includes connecting a Circuit-Switched (CS) call with a second terminal through a CS network, acquiring capability information of the second terminal by performing a Session Initiation Protocol (SIP) capability negotiation process with an IP Multimedia Subsystem (IMS) proxy server through a Packet Switched (PS) network, and transferring files to the second terminal through a File Transfer Protocol (FTP) service using the acquired capability information of the second terminal.

According to another aspect of the present invention, an apparatus for transferring files in a first mobile communication terminal is provided. The apparatus includes an IP Multimedia Subsystem (IMS)-File Transfer Protocol (FTP) application for acquiring capability information of a second terminal which establishes a Circuit-Switched (CS) call with the first terminal through a CS network by performing a Session Initiation Protocol (SIP) capability negotiation process with an IMS proxy server through a Packet Switched (PS) network, and an FTP application for transferring the files to the second terminal through an FTP service using the acquired capability information of the second terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a block diagram of a mobile communication terminal and a network architecture according to an exemplary embodiment of the present invention; and

FIG. 2 is a flowchart illustrating a file transfer method between mobile communication terminals using an IMS service in a mobile communication terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions or constructions are omitted for clarity and conciseness.

The present invention is to provide an apparatus and a method for file transfer using an IMS service in a mobile communication terminal. In the following description, the mobile communication terminal is registered in the network which is able to support an IMS service such as a Global System for a Mobile Communications (GSM) network or a Code Division Multiple Access (CDMA) network.

It is to be understood that the singular forms “a,” “an,” and “the” include plural referents unless the context clearly dictates otherwise. Thus, for example, reference to “a component surface” includes reference to one or more of such surfaces.

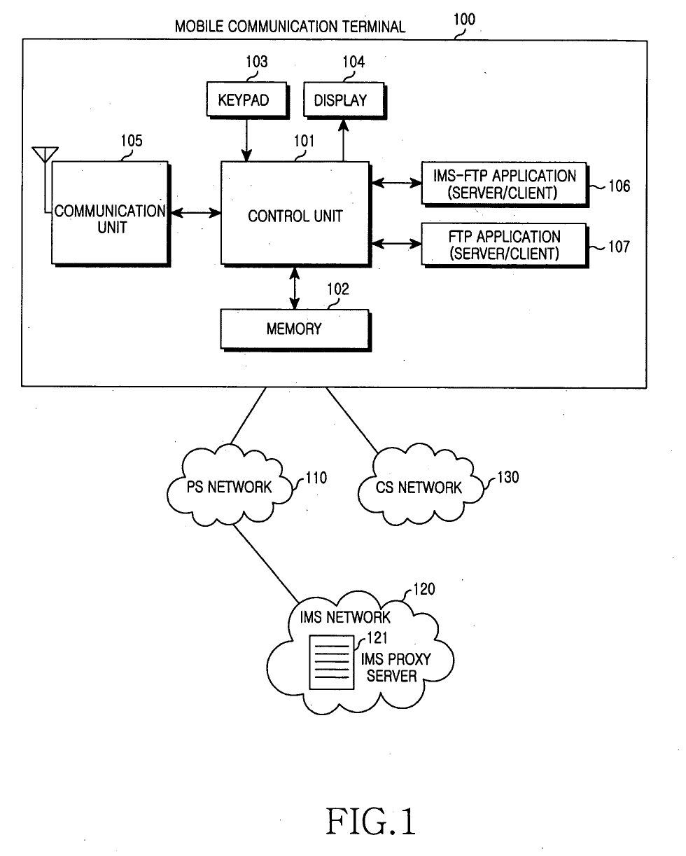

FIG. 1 is a block diagram of a mobile communication terminal and a network architecture according to an exemplary embodiment of the present invention

As described, the mobile communication terminal 100 includes a control unit 101, a memory 102, a keypad 103, a display 104, a communication unit 105, an IMS-File Transfer Protocol (FTP) application 106 and an FTP application 107. The mobile communication terminal 100 is connected with a PS network 110 which is able to support a data call and a CS network 130 which is able to support a voice call. The PS network 110 is connected an IMS network 120 which is able to support an IMS service. The IMS network 120 includes an IMS Proxy Server 121.

Referring to FIG. 1, the control unit 101 provides overall processing and controls to the mobile communication terminal. In addition to conventional functions performed by the control unit 101, the control unit 101 performs a function for acquiring a unique call-ID of the terminal and a corresponding terminal by connecting with the IMS proxy server 121, and for transferring files to the corresponding terminal by using the acquired unique call-ID according to an exemplary embodiment of the present invention.

The memory 102 stores programs for processing and control of the mobile communication terminal, and/or reference data. More particularly, the memory 102 stores the unique call-ID of the terminal and the corresponding terminal acquired by connecting with the IMS proxy server 121 according to an exemplary embodiment of the present invention.

The keypad 103 includes a number of function keys. The keypad 103 provides input data corresponding to a pressed key by a user to the control unit 101.

The display 104 displays status information created during the operation of the mobile communication terminal, characters and numbers. The display unit 104 may be provided as a Liquid Crystal Display (LCD). In this case, the display unit 104 may include a controller for controlling the LCD, a video memory in which image data is stored and an LCD element. If the LCD is provided as a touch screen, the display unit 104 may perform a part or all of the functions of the keypad 103.

The communication unit 105 transmits/receives a radio signal through an antenna. The communication unit 105 is configured to include an RF transmitter (not shown) for up-converting the frequency of transmitted signals and amplifying the transmitted signals, and an RF receiver (not shown) for low-noise amplifying of received RF signals and down-converting the frequency of the received RF signals.

The mobile communication terminal includes the IMS-FTP application 106 as a software block. The IMS-FTP application 106 is able to operate as a server or a client. The IMS-FTP application 106 performs an SIP register process and an SIP capability negotiation process by connecting with the IMS proxy server 121 in the IMS network 120 through the PS network 110 to acquire the unique call-ID of the terminal and the corresponding terminal.

In addition, the mobile communication terminal includes the FTP application 107 as a software block. The FTP application 107 is able to operate as a server or a client. The FTP application 107 transfers files to the corresponding terminal by using the acquired unique call-IDs and FTP commands by connecting with the IMS proxy server 121 in the IMS network 120 through the PS network 110.

The IMS Proxy Server 121 supports file transfer between the mobile communication terminals 100 using an IMS service.

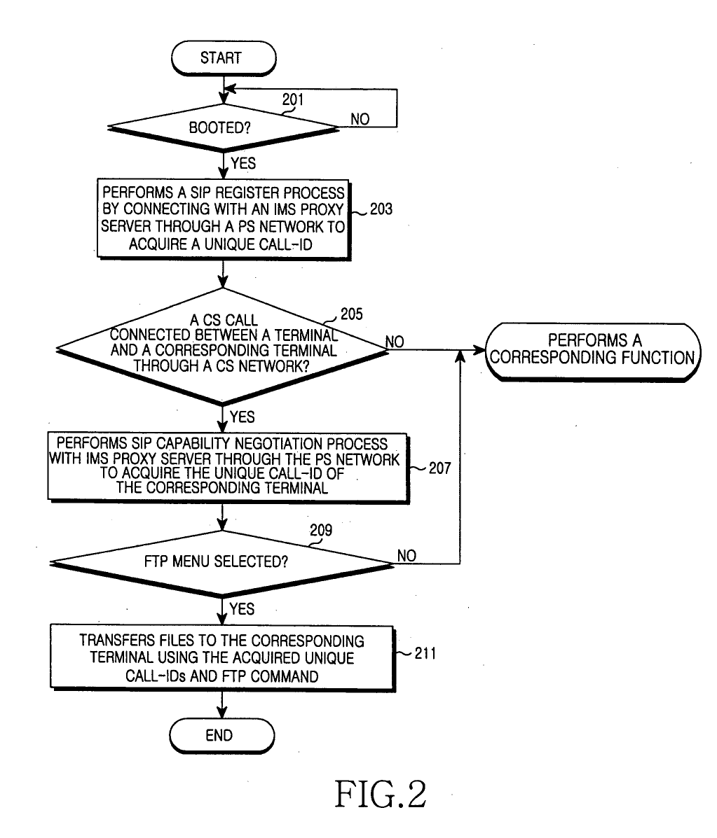

FIG. 2 is a flowchart illustrating a file transfer method between mobile communication terminals using an IMS service in a mobile communication terminal according to an exemplary embodiment of the present invention.

Referring to FIG. 2, in step 201, the mobile communication terminal determines whether the terminal is booted by monitoring a key input from a user. If the terminal is booted, the terminal performs an SIP register process by connecting with an IMS proxy server in an IMS network through a PS network to acquire a unique call-ID, which is assigned to the terminal, using an IMS-FTP application, in step 203. The unique call-ID may include a unique number and an IP address. For example, if the unique call-ID is 15285@10.192.204.10, the assigned unique number for the terminal is 15285 and the IP address using the unique call-ID is 10.192.204.10. At this time, the terminal stores the acquired unique call-ID in a memory, controls an IMS FTP application to be an idle state.

Herein, in the SIP register process, the IMS proxy server 121 transfers 401 Unauthorized message to the terminal when receiving an SIP Register Request message without authentication information. Then the terminal transmits the SIP Register Request message with authentication information to the IMS proxy server.

The SIP Register Request message includes an IP address of the terminal. After that, the terminal transfers the SIP Register Request message with authentication information and IP address to the IMS proxy server 121. Then, the IMS proxy server performs user authentication for the terminal using the authentication information. If the user authentication is succeeded, the IMS proxy server transfers a 200 OK message with the unique call-ID to the terminal.

In step 205, the terminal determines whether a CS call is connected between the terminal and a corresponding terminal which is registered the IMS network through a CS network. If the CS call is not established, the terminal performs a corresponding function. In contrast, if the CS call is established, the terminal performs an SIP capability negotiation process with an IMS proxy server in the IMS network through the PS network to acquire the unique call-ID of the corresponding terminal by operating an IMS-FTP application, in step 207.

Herein, in the SIP capability negotiation process, the terminal transfers an SIP-OPTION message to the corresponding terminal through the IMS proxy server. Herein, the SIP-OPTION message is to request a transfer of capability information of the corresponding terminal. According to an exemplary embodiment of the present invention, the capability information of the corresponding terminal includes the unique call-ID. The corresponding terminal transfers a 200 OK message, which includes capability information of the corresponding terminal, to the terminal. In addition, the corresponding terminal is able to request capability information of the terminal by transferring the SIP-OPTIONS message to the terminal. When the terminal receives the SIP-OPTIONS message, it transfers the 200 OK message, which includes capability information of the terminal, to the corresponding terminal. The terminal and/or the corresponding terminal stores the received capability information in a memory to provide a quick service for the next communication, reduces the network load, and controls an IMS-FTP application to be an idle state.

In step 209, the terminal determines whether an FTP menu is selected by monitoring a key input from a user. If the FTP menu is not selected, the terminal performs a corresponding function. In contrast, if the FTP menu is selected, the terminal transfers files, which are selected by a user, to the corresponding terminal using the acquired unique call-ID of the corresponding terminal and an FTP command by operating an FTP application, in step 211. Herein, the FTP command includes ‘LOGIN’ to login to a server, ‘STORE’ to transfer a file from a client to a server, ‘RETRIEVE’ to transfer a file from a server to a client, ‘QUIT’ to terminate server access and so on.

As described above, exemplary embodiments of the present invention acquire a unique call-ID of terminal and a corresponding terminal by connecting with an IMS proxy server, and transfer files to the corresponding terminal by using the acquired unique call-ID in a mobile communication terminal based on an IMS service. Therefore, the exemplary embodiments of the present invention are able to transfer files, which include different types of data.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transferring files in a first mobile communication terminal, the method comprising:
connecting a Circuit-Switched (CS) call with a second terminal through a CS network;
acquiring capability information of the second terminal by performing a Session Initiation Protocol (SIP) capability negotiation process with an IP Multimedia Subsystem (IMS) proxy server through a Packet Switched (PS) network; and
transferring files to the second terminal through a File Transfer Protocol (FTP) service using the acquired capability information of the second terminal.

2. The method of claim 1, wherein the capability information comprises a unique call-ID of the second terminal.

3. The method of claim 2, wherein the unique call-ID comprises at least one of a unique number and an IP address.

4. The method of claim 1, further comprising:
acquiring capability information of the first terminal by performing an SIP register process with the IMS proxy server,
wherein the transferring of the files uses the acquired capability information of the first terminal and the second terminal.

5. The method of claim 1, further comprising:
storing the acquired capability information.

6. The method of claim 1, wherein the transferring of the files comprising:
determining whether an FTP menu is selected; and
transferring the files if the FTP menu is selected.

7. The method of claim 1, wherein the performing of the SIP capability negotiation process comprising:
transferring an SIP-OPTION message to the second terminal; and
receiving a 200 OK message from the second terminal which includes capability information of the second terminal.

8. An apparatus for transferring files in a first mobile communication terminal, the apparatus comprising:
an IP Multimedia Subsystem (IMS)-File Transfer Protocol (FTP) application for acquiring capability information of a second terminal which establishes a Circuit-Switched (CS) call with the first terminal through a CS network by performing a Session Initiation Protocol (SIP) capability negotiation process with an IMS proxy server through a Packet Switched (PS) network; and
an FTP application for transferring files to the second terminal through an FTP service using the acquired capability information of the second terminal.

9. The apparatus of claim 8, wherein the capability information comprises a unique call-ID of the second terminal.

10. The apparatus of claim 9, wherein the unique call-ID comprises at least one of a unique number and an IP address.

11. The apparatus of claim 8, wherein the IMS-FTP application acquires capability information of the first terminal by performing an SIP register process with the IMS proxy server,
wherein the FTP application transfers the files using the acquired capability information of the first terminal and the second terminal.

12. The apparatus of claim 8, further comprising:
a memory for storing the acquired capability information.

13. The apparatus of claim 8, wherein the FTP application determines whether an FTP menu is selected, and transfers the files if the FTP menu is selected.

14. The apparatus of claim 8, wherein in the SIP capability negotiation process, the IMS FTP application transfers an SIP-OPTION message to the second terminal, and receives a 200 OK message from the second terminal which includes capability information of the second terminal.

15. An apparatus for transferring files in a first mobile communication terminal, the apparatus comprising:
means for connecting a Circuit-Switched (CS) call with a second terminal through a CS network;
means for acquiring capability information of the second terminal by performing a Session Initiation Protocol (SIP) capability negotiation process with an IP Multimedia Subsystem (IMS) proxy server through a Packet Switched (PS) network; and
means for transferring files to the second terminal through a File Transfer Protocol (FTP) service using the acquired capability information of the second terminal.
